(19) United States
(12) Patent Application Publication
(10) Pub. No.: US 2025/0301302 A1
(43) Pub. Date: Sep. 25, 2025

(54) URSP RULE PROVISIONING IN ROAMING

(71) Applicant: Telefonaktiebolaget LM Ericsson (publ), Stockholm (SE)

(72) Inventors: Maria Belen Pancorbo Marcos, Madrid (ES); Juying Gan, Shanghai (CN); Antonio Iniesta Gonzalez, Madrid (ES)

(21) Appl. No.: 18/863,406

(22) PCT Filed: May 5, 2023
(86) PCT No.: PCT/EP2023/061990

§ 371 Date: Nov. 6, 2024

(30) Foreign Application Priority Data
May 6, 2022 (EP) 22382438.4

(51) Int. Cl. H04W 8/12; H04W 84/04

(52) U.S. Cl. CPC H04W 8/12; H04W 84/042

(57) ABSTRACT

Providing User Equipment (UE) Routing and Selection Policy (URSP) provisioning in roaming is disclosed herein. In one embodiment, a method performed by a Visiting Policy Control Function (V-PCF) of a Visiting Public Land Mobile Network (VPLMN) comprises, responsive to UE registration in the VPLMN and establishment of a UE Policy Association between a Home Policy Control Function (H-PCF) of a Home Public Land Mobile Network (HPLMN) and the V-PCF, receiving HPLMN UE policy subscription data for a registered Subscription Permanent Identifier (SUPI) from the H-PCF, and generating URSP rules for the UE in the VPLMN. The V-PCF determines, based on the subscription data, whether Local Breakout (LBO) roaming is allowed for a combination of Data Network Name (DNN) and Single Network Slice Selection Assistance Information (S-NSSAI) in one or more Route Selection Descriptor (RSD) components in the URSP rules, and, if so, transmits the URSP rules to the UE.

### RELATED APPLICATIONS

This application claims the benefit of European patent application serial number 22382438.4, filed May 6, 2022, the disclosure of which is hereby incorporated herein by reference in its entirety.

### TECHNICAL FIELD

The present disclosure relates to User Equipment (UE) Routing and Selection Policy (URSP) rule provisioning in a cellular communications system.

### BACKGROUND

The 5GC provides policy information from the PCF to the UE. Such UE policy information may include different types of policies such as ANDSP, URSP, V2XP and ProseP, as non-limiting examples. FIG. 1, which illustrates an exemplary 5G system architecture, and the text excerpted from 3GPP TR 23.700-85 in Table 1 below describe one issue with URSP in a Visited Public Land Mobile Network (VPLMN):

TABLE 1
Key Issue #1: URSP in VPLMN (TR 23.700-85)
This KI is part of the REl-18 SID on FS_eUEPO.
This Key Issue will study URSP rule provisioning and updating procedures in roaming
scenario, while keeping backward compatibility with the existing framework of policy
control based on HPLMN. In particular:

| | |
|---|---|
| - | Whether the HPLMN needs any information from the VPLMN to generate URSP |
| | Rules in roaming. If so, which information and how to provide it. |
| - | How to provide URSP Rules in roaming to the UE. In particular, how the HPLMN |
| | and VPLMN are involved in such procedure. |
| - | Whether and how to support URSP enhancements to support routing of the |
| | application traffic with different URSP rules in different PLMNs. |

Solutions have been included in the TR 23.700-85 v. 0.2.0 that proposes that the
HPLMN provides URSP Rules, then one solution for the VPLMN was discussed while
not accepted, as such is not part of the TR, and still existing technology. See, S2-
2202066

### SUMMARY

Methods and apparatus are disclosed herein for providing User Equipment (UE) Routing and Selection Policy (URSP) provisioning in roaming. Embodiments disclosed herein enable a Visiting Policy Control Function (V-PCF) to provision or update URSP Rules to a UE while complying with the Single Network Slice Selection Assistance Information (S-NSSAI) and Data Network Name (DNN) subscribed values, which facilitates successful Protocol Data Unit (PDU) Session Establishment in Local Breakout (LBO) mode and successful subscription check at an Access and Mobility Function (AMF) and a Session Management Function (SMF).

Embodiments of a method performed by a Home Policy Control Function (H-PCF) of a Home Public Land Mobile Network (HPLMN) of a cellular communications system for providing URSP rule provisioning in roaming are disclosed herein. The method comprises providing HPLMN UE policy subscription data for a Subscription Permanent Identifier (SUPI) to a V-PCF of a Visiting Public Land Mobile Network (VPLMN) the HPLMN UE policy subscription data comprising an indication of whether LBO roaming by a UE is allowed for one or more specified combinations of DNN and S-NSSAI. Some embodiments may provide that providing the HPLMN UE policy subscription data for the SUPI to the V-PCF is responsive to the UE registering in the VPLMN and a UE Policy Association being established between the H-PCF and the V-PCF. In some embodiments, providing the HPLMN UE policy subscription data for the SUPI to the V-PCF is responsive to an update of a UE Policy Association providing a new Public Land Mobile Network Identifier (PLMN-ID).

Embodiments of a network node implementing a H-PCF of a HPLMN of a cellular communications system for providing URSP rule provisioning in roaming are also disclosed herein. The network node comprises one or more transmitters, one or more receivers, and processing circuitry associated with the one or more transmitters and the one or more receivers. The processing circuitry is configured to cause the network node to provide HPLMN UE policy subscription data for a SUPI to the V-PCF, the HPLMN UE policy subscription data comprising an indication of whether LBO roaming by the UE is allowed for one or more specified combinations of DNN and S-NSSAI. According to some embodiments, the processing circuitry is configured to cause the network node to perform any of the operations attributed to the network node above.

Embodiments of a network node implementing a H-PCF of a HPLMN of a cellular communications system for providing URSP rule provisioning in roaming are also disclosed herein. The network node is adapted to provide HPLMN UE policy subscription data for a SUPI to the V-PCF, the HPLMN UE policy subscription data comprising an indication of whether LBO roaming by the UE is allowed for one or more specified combinations of DNN and S-NSSAI. Some embodiments may provide that the network node is adapted to perform any of the operations attributed to the network node above.

Embodiments of a method performed by a V-PCF of a VPLMN of a cellular communications system for providing URSP rule provisioning in roaming are also disclosed herein. The method comprises, responsive to a UE registering in the VPLMN and a UE Policy Association being established between a H-PCF of a HPLMN and the V-PCF of the VPLMN, receiving HPLMN UE policy subscription data for a SUPI from the H-PCF. The method further comprises generating URSP rules for the UE in the VPLMN. The method also comprises determining, based on the HPLMN UE policy subscription data, whether LBO roaming is allowed for one or more specified combinations of DNN and S-NSSAI in one or more Route Selection Descriptor (RSD) components in the URSP rules. The method additionally comprises, responsive to determining that LBO roaming is allowed, transmitting the URSP rules to the UE. In some embodiments, generating the URSP rules for the UE in the VPLMN comprises providing a list of Policy Section Identifiers (PSIs) including an identifier of the VPLMN.

Embodiments of a network node implementing a V-PCF of a VPLMN of a cellular communications system for providing URSP rule provisioning in roaming are also disclosed herein. The network node comprises one or more transmitters, one or more receivers, and processing circuitry associated with the one or more transmitters and the one or more receivers. The processing circuitry is configured to cause the network node to, responsive to a UE registering in the VPLMN and a UE Policy Association being established between a H-PCF of a HPLMN and the V-PCF of the VPLMN, receive HPLMN UE policy subscription data for a SUPI from the H-PCF. The processing circuitry is further configured to cause the network node to generate URSP rules for the UE in the VPLMN. The processing circuitry is also configured to cause the network node to determine, based on the HPLMN UE policy subscription data, whether LBO roaming is allowed for one or more specified combinations of DNN and S-NSSAI in one or more RSD components in the URSP rules. The processing circuitry is additionally configured to cause the network node to, responsive to determining that LBO roaming is allowed, transmit the URSP rules to the UE. According to some embodiments, the processing circuitry is configured to cause the network node to perform any of the operations attributed to the network node above.

Embodiments of a network node implementing a V-PCF of a VPLMN of a cellular communications system for providing URSP rule provisioning in roaming are also disclosed herein. The network node is adapted to, responsive to a UE registering in the VPLMN and a UE Policy Association being established between a H-PCF of a HPLMN and the V-PCF of the VPLMN, receive HPLMN UE policy subscription data for a SUPI from the H-PCF. The network node is further adapted to generate URSP rules for the UE in the VPLMN. The network node is also adapted to determine, based on the HPLMN UE policy subscription data, whether LBO roaming is allowed for one or more specified combinations of DNN and S-NSSAI in one or more RSD components in the URSP rules. The network node is additionally adapted to, responsive to determining that LBO roaming is allowed, transmit the URSP rules to the UE. Some embodiments may provide that the network node is adapted to perform any of the operations attributed to the network node above.

Embodiments of a method performed by a UE of a cellular communications system for providing URSP rule provisioning in roaming are also disclosed herein. The method comprises determining, based on checking VPLMN-generated URSP rules prior to URSP rules received from a HPLMN whether a S-NSSAI is contained within a list of allowed S-NSSAIs. The method further comprises, responsive at least to determining that the S-NSSAI is contained within the list of allowed S-NSSAIs, determining that an RSD component of the VPLMN-generated URSP rules is valid.

In some embodiments, the method further comprises receiving, from a V-PCF of a VPLMN, the VPLMN-generated URSP rules. According to some embodiments, the method further comprises registering, by the UE, in the VPLMN, wherein the UE was previously provisioned with the VPLMN-generated URSP rules by the V-PCF and the URSP rules received from the HPLMN. Some embodiments may provide that the UE was previously provisioned with one of the VPLMN-generated URSP rules by the V-PCF and the URSP rules received from the HPLMN. In some embodiments, the method further comprises identifying the VPLMN-generated URSP rules by verifying that a PLMN-ID in a list of PSIs includes an identifier of the VPLMN.

Embodiments of a UE are also disclosed herein. The UE comprises one or more transmitters, one or more receivers, and processing circuitry associated with the one or more transmitters and the one or more receivers. The processing circuitry is configured to cause the UE to determine, based on checking VPLMN-generated URSP rules prior to URSP rules received from a HPLMN whether a S-NSSAI is contained within 5 a list of allowed S-NSSAIs. The processing circuitry is further configured to cause the UE to, responsive at least to determining that the S-NSSAI is contained within the list of allowed S-NSSAIs, determining that an RSD component of the VPLMN-generated URSP rules is valid. According to some embodiments, the processing circuitry is configured to cause the UE to perform any of the operations attributed to the UE above.

Embodiments of a UE are also disclosed herein. The UE is adapted to determine, based on checking VPLMN-generated URSP rules prior to URSP rules received from a HPLMN whether a S-NSSAI is contained within a list of allowed S-NSSAIs. The UE is further adapted to, responsive at least to determining that the S-NSSAI is contained within the list of allowed S-NSSAIs, determining that an RSD component of the VPLMN-generated URSP rules is valid. Some embodiments may provide that the UE is adapted to perform any of the operations attributed to the UE above.

Embodiments of a cellular communications system comprising a network node implementing a H-PCF of a HPLMN a network node implementing a V-PCF of a VPLMN and a UE are disclosed herein. The network node implementing the H-PCF of the HPLMN is adapted to provide HPLMN UE policy subscription data for a SUPI to the V-PCF, the HPLMN UE policy subscription data comprising an indication of whether LBO roaming by the UE is allowed for one or more specified combinations of DNN and S-NSSAI. The network node implementing the V-PCF of the VPLMN is adapted to, responsive to the UE registering in the VPLMN and the UE Policy Association being established between the H-PCF of the HPLMN and the V-PCF of the VPLMN, receive the HPLMN UE policy subscription data for the SUPI from the H-PCF. The network node implementing the V-PCF of the VPLMN is further adapted to generate URSP rules for the UE in the VPLMN. The network node implementing the V-PCF of the VPLMN is also adapted to determine, based on the HPLMN UE policy subscription data, whether LBO roaming is allowed for a specified DNN or one or more specified combinations of DNN and S-NSSAI in one or more RSD components in the URSP rules. The network node implementing the V-PCF of the VPLMN is additionally adapted to, responsive to determining that LBO roaming is allowed, transmit the URSP rules to the UE. The UE is adapted to determine, based on checking the VPLMN-generated URSP rules received from the V-PCF prior to URSP rules received from the HPLMN, whether a S-NSSAI is contained within a list of allowed S-NSSAIs. The UE is further adapted to, responsive at least to determining that the S-NSSAI is contained within the list of allowed S-NSSAIs, determine that an RSD component of the VPLMN-generated URSP rules is valid.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary Fifth Generation (5G) system architecture;

FIG. 2 illustrates one example of a cellular communications system according to some embodiments of the present disclosure;

FIGS. 3 and 4 illustrate example embodiments in which the cellular communication system of FIG. 2 is a 5G System (5GS);

FIG. 5 is a message flow diagram illustrating exemplary communications among and operations performed by an Access and Mobility Function (AMF), a Visiting Policy Control Function (V-PCF), and a Home Policy Control Function (H-PCF) of a cellular communications network for performing User Equipment (UE) Policy Association Establishment when roaming (wherein the Visiting Public Land Mobile Network (VPLMN) provides UE Routing and Selection Policy (URSP) Rules);

FIG. 6 is a flowchart illustrating exemplary operations of a UE for providing URSP rule provisioning in roaming;

FIG. 7 is a schematic block diagram of a radio access node according to some embodiments of the present disclosure;

FIG. 8 is a schematic block diagram that illustrates a virtualized embodiment of the radio access node of FIG. 7 according to some embodiments of the present disclosure;

FIG. 9 is a schematic block diagram of the radio access node of FIG. 7 according to some other embodiments of the present disclosure;

FIG. 10 is a schematic block diagram of a UE device according to some embodiments of the present disclosure; and

FIG. 11 is a schematic block diagram of the UE of FIG. 10 according to some other embodiments of the present disclosure.

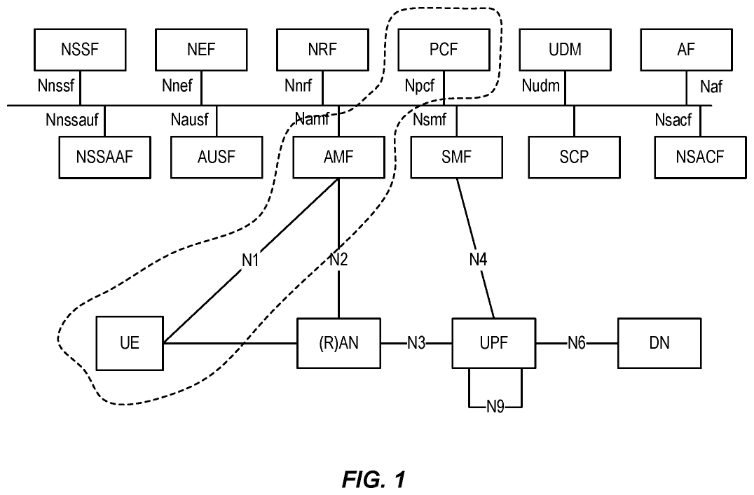

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s) with existing approaches. In particular, there exists published technology that proposes that the V-PCF sends URSP Rules to the UE. However, a problem arises in that the UE that tries to establish a PDU Session with VPLMN provided URSP Rules will fail, first because the UE checks the S-NSSAI in the RSD with the Allowed S-NSSAI mapped to the HPLMN S-NSSAI and then because the S-NSSAI and DNN in the PDU Session establishment will not pass the subscription check at the AMF and SMF, but are rather unknown values to the HPLMN.

Accordingly, the present disclosure and embodiments therein may provide solutions to the aforementioned or other challenges. There are, proposed herein, various embodiments which address one or more of the issues disclosed herein. Some embodiments provide that the V-PCF sends URSP Rules to the UE to route traffic when the UE is registered at the VPLMN. This enables PDU Sessions in LBO mode. The URSP Rules comply with the subscription information as provided by the HPLMN at UE Policy Association Establishment. The V-PCF needs to have the mapping of the DNN and S-NSSAI values at the VPLMN to the HPLMN ones.

According to some embodiments, when the UE is roaming, the VPLMN can provide URSP Rules to the UE in addition to those provided by the HPLMN. In order to enable this the following is needed:
The HPLMN UE policy subscription data stored in the UDR is extended to indicate if LBO roaming is allowed for a certain DNN, S-NSSAI combination.
When the UE registers in the VPLMN and the UE Policy Association is established between the H-PCF and the V-PCF, the UE Policy subscription data for the registered SUPI is provided to the V-PCF.
The V-PCF can generate URSP Rules for the UE traffic in the VPLMN, then checks if LBO roaming is allowed for the DNN, S-NSSAI in each of the RSD components in the URSP Rule. Note that the V-PCF maps the VPLMN DNN and S-NSSAI values into the HPLMN DNN, S-NSSAI values to be able to check the UE Policy Subscription Data. If the subscription check allows, the V-PCF sends the URSP Rules to the UE.
The UE checks the VPLMN provided URSP Rules prior to the HPLMN provided URSP Rules. For VPLMN provided URSP Rules, the RSD component is considered valid if the S-NSSAI is in the list of Allowed S-NSSAIs.

Certain embodiments may provide one or more of the following technical advantage(s). In particular, embodiments disclosed herein enable the V-PCF to provision or update URSP Rules to UE while complying with the S-NSSAI and DNN subscribed values, which enables successful PDU Session Establishment in LBO mode and successful subscription check at the AMF and SMF.

Before discussing for methods and apparatus for URSP rule provisioning in roaming in greater detail, terminology used herein is first defined as follows:

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

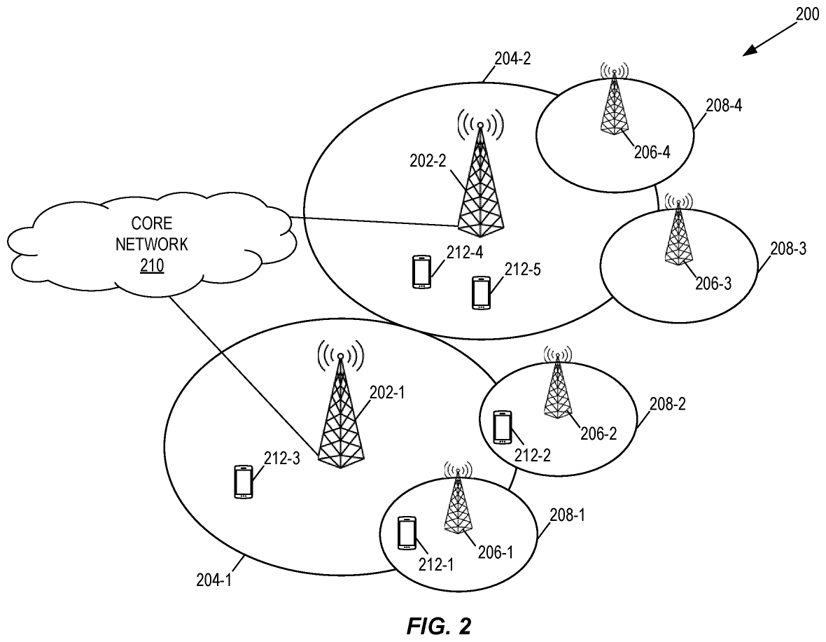

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210. The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

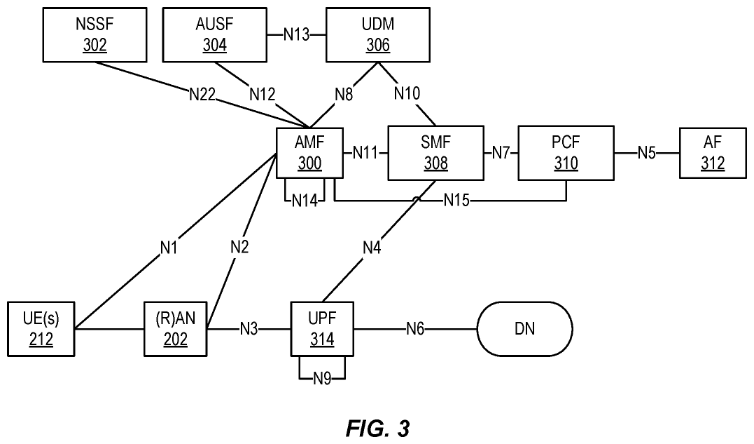

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises base stations, e.g. such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

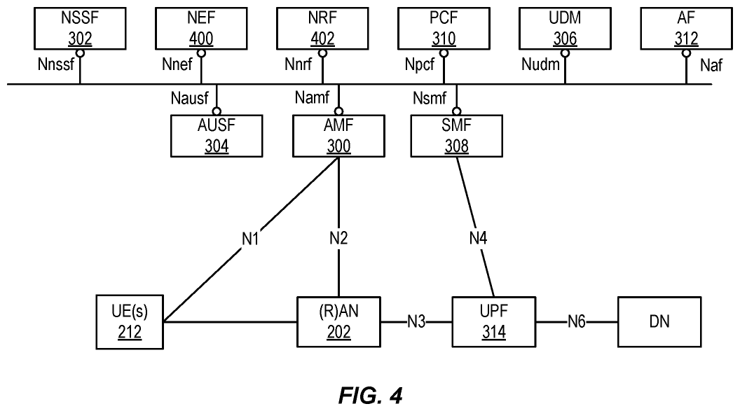

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g., Namf for the service based interface of the AMF 300 and Nsmf for the service based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

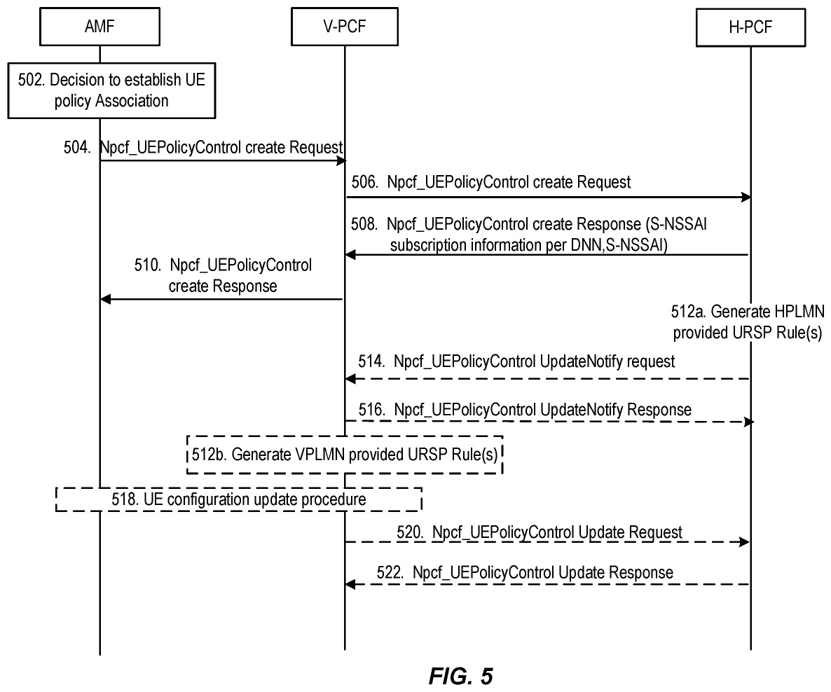

Embodiments for providing URSP rule provisioning in roaming are now discussed. In this regard, FIG. 5 provides a message flow diagram illustrating exemplary communications among and operations performed by an AMF, a V-PCF, and an H-PCF of a cellular communications network for performing UE Policy Association Establishment when roaming (wherein the VPLMN provides URSP Rules). The procedure illustrated in FIG. 5 takes the UE Policy Association Establishment procedure in roaming case as specified in clause 4.16.11 of TS 23.502 as basis:
Steps 502, 504 and 506 are the same as step 1, 2 and 3 in clause 4.16.11 of TS 23.502.
Step 508 is the same as step 4 in in clause 4.16.11 of TS 23.502, but in addition the H-PCF may include the S-NSSAI subscription information defined in Table 2 below. The S-NSSAI subscription information is stored at the UDR at the HPLMN, provided to the H-PCF. The H-PCF sends the S-NSSAI subscription information to the VPLMN based on local policies that states whether VPLMN can provide URSP Rules to the UE and whether the LBO roaming is allowed. The H-PCF only provides S-NSSAI subscription information for this DNNs or (S-NSSAI and DNN) combinations that has LBO roaming allowed set.
Step 510 is the same as step 4 in in clause 4.16.11 of TS 23.502, but in addition the V-PCF stores the S-NSSAI subscription information as part of the UE Context and may provide additional PCRTs to the AMF.
Regarding steps 512a, 514 and 516, the (H-) PCF may create a UE Policy Container to be sent to the UE as defined in steps 7 and 8 4.16.11 of TS 23.502.
At step 512b, the (V-) PCF may create a UE Policy Container to be delivered to the UE if the subscription information allows for LBO in roaming for those DNN,S-NNSAIs in the RSD components. The V-PCF generates URSP Rules for traffic that will be offloaded at the VPLMN, either due to AF providing Application guidance for URSP rules determination for “any UE”, defined in clause 6.6 of TS 23.548 or due to local policies at the V-PCF. The V-PCF may decide to offload application traffic to a certain DNN, S-NSSAI based e.g., on load in the network that can be derived from analytics at certain time of day. The V-PCF provides the list of PSIs including the VPLMN ID to identify them at the UE. Note that if Step 512b happens it takes place at anytime after step 510.
At step 518, the (V-) PCF triggers UE Configuration Update Procedure to send the UE policy container as defined in step 8 in clause 4.5.11 of TS 23.502.
At step 520, the V-PCF checks if the notification response is treated locally or is to be sent to the H-PCF, if so step 9 in clause 4.5.11 of TS 23.502 occurs.
Step 522 is the same as step 10 in H-PCF clause 4.5.11 of TS 23.502.

TABLE 2

| Information | | |
|---|---|---|
| name | Description | Category |
| Subscriber | List of category identifiers associated | Optional |
| categories | with the subscriber | |
| Tracing | Tracing requirements as defined in | Optional |
| Requirements | TS 32.421 | |
| PEI | The Permanent Equipment Identifier | Optional |
| | of the UE. | |
| OSId | Identifies the operating system supported | Optional |
| | by UE. | |
| Indication of | Indicates the UE support for ANDSP. | Optional |
| UE support for | | |
| ANDSP | | |
| S-NSSAI | Contains the list of subscribed S-NSSAIs, | Optional |
| subscription | its associated subscribed DNNs. For each | |
| information | DNN, it includes the Allowed PDU Session | |
| | types, the Allowed SSC modes, the ATSSS | |
| | information and the LBO roaming | |
| | information (NOTE). | |

(NOTE):
ATSSS information is defined in TS 23.502 Table 5.2.3.3.1-1 and Indicates whether MA PDU Session establishment is allowed. LBO roaming is defined in TS 23.502 Table 5.2.3.3.1-1 and Indicates whether LBO roaming is allowed per DNN or per (S-NSSAI and DNN)

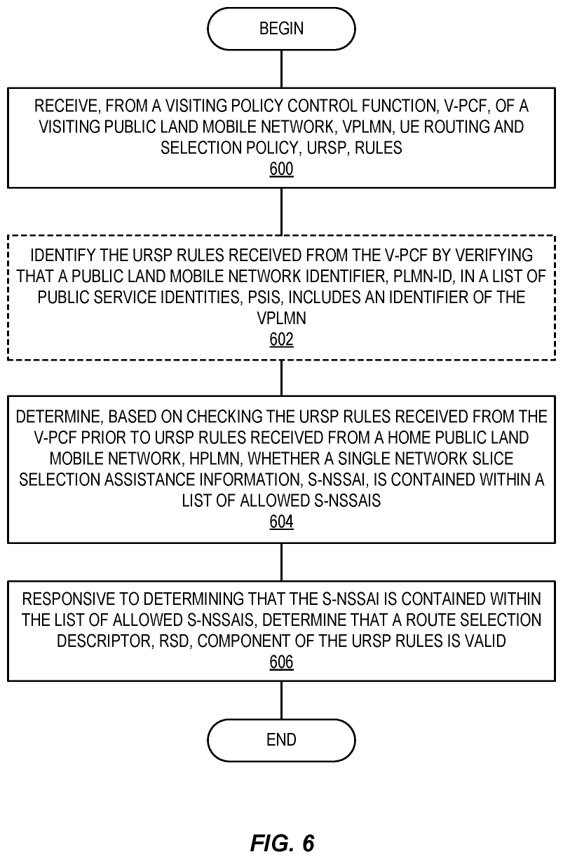

FIG. 6 provides a flowchart illustrating exemplary operations of a UE for performing URSP rule provisioning in roaming. Operations in FIG. 6 begin with the UE receiving, from a V-PCF of a VPLMN, URSP rules (block 600). In some embodiments, the UE identifies the URSP rules received from the V-PCF by verifying that a Public Land Mobile Network Identifier (PLMN-ID) in a list of Policy Section Identifiers (PSIs) includes an identifier of the VPLMN (block 602). The UE determines, based on checking the URSP rules received from the V-PCF prior to URSP rules received from an HPLMN, whether a S-NSSAI is contained within a list of allowed S-NSSAIs (block 604). The UE, responsive to determining that the S-NSSAI is contained within the list of allowed S-NSSAIs, determines that an RSD component of the URSP rules is valid (block 606).

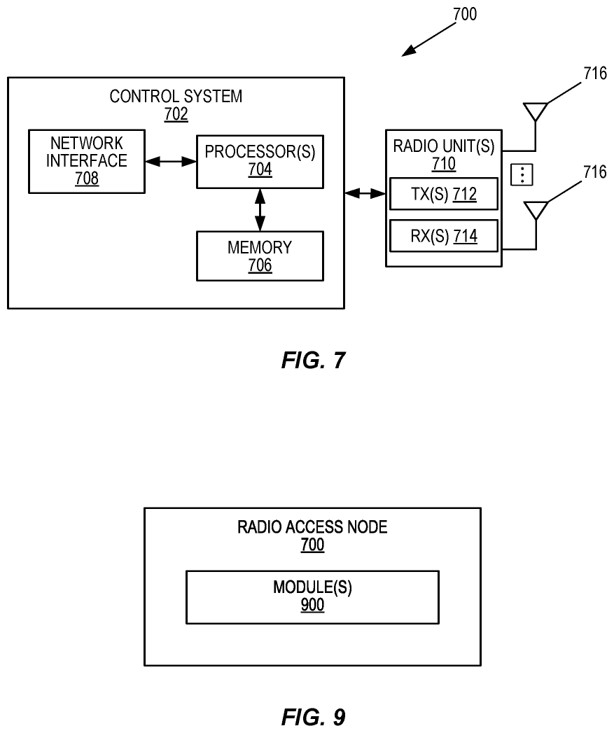

FIG. 7 is a schematic block diagram of a radio access node 700 according to some embodiments of the present disclosure. Optional features are represented by dashed boxes. The radio access node 700 may be, for example, a base station 202 or 206 or a network node that implements all or part of the functionality of the base station 202 or gNB described herein. As illustrated, the radio access node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of a radio access node 700 as described herein. In some embodiments, the function(s) are implemented in software that is stored, e.g., in the memory 706 and executed by the one or more processors 704.

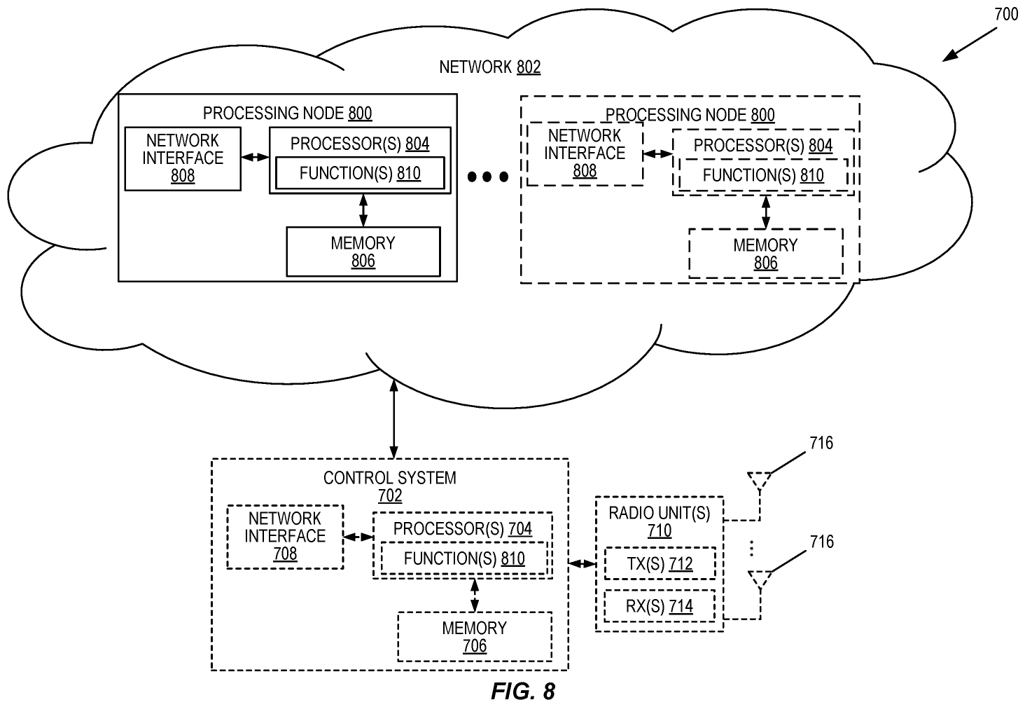

FIG. 8 is a schematic block diagram that illustrates a virtualized embodiment of the radio access node 700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 700 in which at least a portion of the functionality of the radio access node 700 is implemented as a virtual component(s) (e.g., via a virtual machine(s) executing on a physical processing node(s) in a network(s)). As illustrated, in this example, the radio access node 700 may include the control system 702 and/or the one or more radio units 710, as described above. The control system 702 may be connected to the radio unit(s) 710 via, for example, an optical cable or the like. The radio access node 700 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICs, FPGAS, and/or the like), memory 806, and a network interface 808.

In this example, functions 810 of the radio access node 700 described herein are implemented at the one or more processing nodes 800 or distributed across the one or more processing nodes 800 and the control system 702 and/or the radio unit(s) 710 in any desired manner. In some particular embodiments, some or all of the functions 810 of the radio access node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of radio access node 700 or a node (e.g., a processing node 800) implementing one or more of the functions 810 of the radio access node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the radio access node 700 according to some other embodiments of the present disclosure. The radio access node 700 includes one or more modules 900, each of which is implemented in software. The module(s) 900 provide the functionality of the radio access node 700 described herein. This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

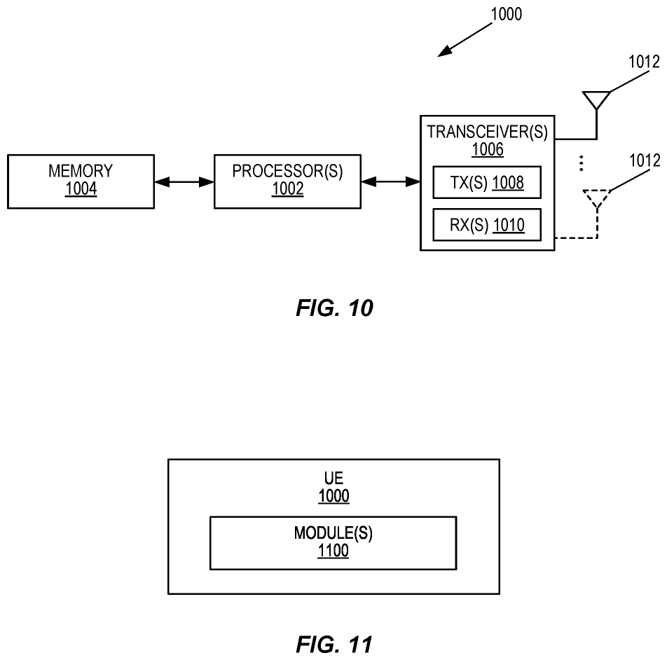

FIG. 10 is a schematic block diagram of a wireless communication device 1000 according to some embodiments of the present disclosure. As illustrated, the wireless communication device 1000 includes one or more processors 1002 (e.g., CPUs, ASICS, FPGAs, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the wireless communication device 1000 described above may be fully or partially implemented in software that is, e.g., stored in the memory 1004 and executed by the processor(s) 1002. Note that the wireless communication device 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 1000 and/or allowing output of information from the wireless communication device 1000), a power supply (e.g., a battery and associated power circuitry), etc.

In some embodiments, a computer program including instructions which, when executed by at least one processor, causes the at least one processor to carry out the functionality of the wireless communication device 1000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the wireless communication device 1000 according to some other embodiments of the present disclosure. The wireless communication device 1000 includes one or more modules 1100, each of which is implemented in software. The module(s) 1100 provide the functionality of the wireless communication device 1000 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

While not being limited thereto, some example embodiments of the present disclosure are provided below.

Embodiment 1: A method performed by a Home Policy Control Function, H-PCF, of a Home Public Land Mobile Network, HPLMN, of a cellular communications system for providing User Equipment, UE, Routing and Selection Policy, URSP, rule provisioning and roaming, the method comprising:
responsive to a UE registering in a Visiting Public Land Mobile Network, VPLMN, and a UE Policy Association being established between the H-PCF and a Visiting Policy Control Function, V-PCF, of the VPLMN, providing HPLMN UE policy subscription data for a registered Subscription Permanent Identifier, SUPI, to the V-PCF, the HPLMN UE policy subscription data comprising an indication of whether Local Breakout, LBO, roaming by the UE is allowed for a specified combination of Data Network Name, DNN, and Single Network Slice Selection Assistance Information, S-NSSAI.

Embodiment 2: A network node implementing a Home Policy Control Function, H-PCF, of a Home Public Land Mobile Network, HPLMN, of a cellular communications system for providing User Equipment, UE, Routing and Selection Policy, URSP, rule provisioning and roaming, the network node comprising:
one or more transmitters;
one or more receivers; and
processing circuitry associated with the one or more transmitters and the one or more receivers, the processing circuitry configured to cause the network node to:
   responsive to a UE registering in a Visiting Public Land Mobile Network, VPLMN, and a UE Policy Association being established between the H-PCF and a Visiting Policy Control Function, V-PCF, of the VPLMN, provide HPLMN UE policy subscription data for a registered Subscription Permanent Identifier, SUPI, to the V-PCF, the HPLMN UE policy subscription data comprising an indication of whether Local Breakout, LBO, roaming by the UE is allowed for a specified combination of Data Network Name, DNN, and Single Network Slice Selection Assistance Information, S-NSSAI.

Embodiment 3: A network node implementing a Home Policy Control Function, H-PCF, of a Home Public Land Mobile Network, HPLMN, of a cellular communications system for providing User Equipment, UE, Routing and Selection Policy, URSP, rule provisioning and roaming, the network node adapted to:
responsive to a UE registering in a Visiting Public Land Mobile Network, VPLMN, and a UE Policy Association being established between the H-PCF and a Visiting Policy Control Function, V-PCF, of the VPLMN, provide HPLMN UE policy subscription data for a registered Subscription Permanent Identifier, SUPI, to the V-PCF, the HPLMN UE policy subscription data comprising an indication of whether Local Breakout, LBO, roaming by the UE is allowed for a specified combination of Data Network Name, DNN, and Single Network Slice Selection Assistance Information, S-NSSAI.

Embodiment 4: A method performed by a Visiting Policy Control Function, V-PCF, of a Visiting Public Land Mobile Network, VPLMN, of a cellular communications system for providing User Equipment, UE, Routing and Selection Policy, URSP, rule provisioning and roaming, the method comprising:
responsive to a UE registering in the VPLMN and a UE Policy Association being established between a Home Policy Control Function, H-PCF, of a Home Public Land Mobile Network, HPLMN, and the V-PCF of the VPLMN, receiving HPLMN UE policy subscription data for a registered Subscription Permanent Identifier, SUPI, from the H-PCF;
generating URSP rules for the UE in the VPLMN;
determining, based on the HPLMN UE policy subscription data, whether Local Breakout, LBO, roaming is allowed for a specified combination of Data Network Name, DNN, and Single Network Slice Selection Assistance Information, S-NSSAI, in one or more Route Selection Descriptor, RSD, components in the URSP rules; and
responsive to determining that LBO roaming is allowed, transmitting the URSP rules to the UE.

Embodiment 5: The method of embodiment 4, wherein generating the URSP rules for the UE in the VPLMN comprises providing a list of Policy Section Identifiers, PSIs, including an identifier of the VPLMN.

Embodiment 6: A network node implementing a Visiting Policy Control Function, V-PCF, of a Visiting Public Land Mobile Network, VPLMN, of a cellular communications system for providing User Equipment, UE, Routing and Selection Policy, URSP, rule provisioning and roaming, the network node comprising:
one or more transmitters;
one or more receivers; and
processing circuitry associated with the one or more transmitters and the one or more receivers, the processing circuitry configured to cause the network node to:
   responsive to a UE registering in the VPLMN and a UE Policy Association being established between a Home Policy Control Function, H-PCF, of a Home Public Land Mobile Network, HPLMN, and the V-PCF of the VPLMN, receive HPLMN UE policy subscription data for a registered Subscription Permanent Identifier, SUPI, from the H-PCF;
   generate URSP rules for the UE in the VPLMN;
   determine, based on the HPLMN UE policy subscription data, whether Local Breakout, LBO, roaming is allowed for a specified combination of Data Network Name, DNN, and Single Network Slice Selection Assistance Information, S-NSSAI, in one or more Route Selection Descriptor, RSD, components in the URSP rules; and
   responsive to determining that LBO roaming is allowed, transmit the URSP rules to the UE.

Embodiment 7: The network node of embodiment 6, wherein the processing circuitry is further configured to cause the network node to perform the method of embodiment 5.

Embodiment 8: A network node implementing a Visiting Policy Control Function, V-PCF, of a Visiting Public Land Mobile Network, VPLMN, of a cellular communications system for providing User Equipment, UE, Routing and Selection Policy, URSP, rule provisioning and roaming, the network node adapted to:
responsive to a UE registering in the VPLMN and a UE Policy Association being established between a Home Policy Control Function, H-PCF, of a Home Public Land Mobile Network, HPLMN, and the V-PCF of the VPLMN, receive HPLMN UE policy subscription data for a registered Subscription Permanent Identifier, SUPI, from the H-PCF;
generate URSP rules for the UE in the VPLMN;
determine, based on the HPLMN UE policy subscription data, whether Local Breakout, LBO, roaming is allowed for a specified combination of Data Network Name, DNN, and Single Network Slice Selection Assistance Information, S-NSSAI, in one or more Route Selection Descriptor, RSD, components in the URSP rules; and
responsive to determining that LBO roaming is allowed, transmit the URSP rules to the UE.

Embodiment 9: The network node of embodiment 8, wherein the network node is further adapted to perform the method of embodiment 5.

Embodiment 10: A method performed by a User Equipment, UE, of a cellular communications system for providing UE Routing and Selection Policy, URSP, rule provisioning and roaming, the method comprising:
receiving, from a Visiting Policy Control Function, V-PCF, of a Visiting Public Land Mobile Network, VPLMN, URSP rules;
determining, based on checking the URSP rules received from the V-PCF prior to URSP rules received from a Home Public Land Mobile Network, HPLMN, whether a Single Network Slice Selection Assistance Information, S-NSSAI, is contained within a list of allowed S-NSSAIs; and
responsive to determining that the S-NSSAI is contained within the list of allowed S-NSSAIs, determining that a Route Selection Descriptor, RSD, component of the URSP rules is valid.

Embodiment 11: The method of embodiment 10, further comprising identifying the URSP rules received from the V-PCF by verifying that a Public Land Mobile Network Identifier, PLMN-ID, in a list of Policy Section Identifiers, PSIs, includes an identifier of the VPLMN.

Embodiment 12: A User Equipment, UE, comprising:
one or more transmitters;
one or more receivers; and
processing circuitry associated with the one or more transmitters and the one or more receivers, the processing circuitry configured to cause the UE to:
   receive, from a Visiting Policy Control Function, V-PCF, of a Visiting Public Land Mobile Network, VPLMN, UE Routing and Selection Policy, URSP, rules;
   determine, based on checking the URSP rules received from the V-PCF prior to URSP rules received from a Home Public Land Mobile Network, HPLMN, whether a Single Network Slice Selection Assistance Information, S-NSSAI, is contained within a list of allowed S-NSSAIs; and
   responsive to determining that the S-NSSAI is contained within the list of allowed S-NSSAIs, determine that a Route Selection Descriptor, RSD, component of the URSP rules is valid.

Embodiment 13: The UE of embodiment 11, wherein the processing circuitry is further configured to cause the UE to perform the method of embodiment 11.

Embodiment 14: A User Equipment, UE, adapted to:
receive, from a Visiting Policy Control Function, V-PCF, of a Visiting Public Land Mobile Network, VPLMN, UE Routing and Selection Policy, URSP, rules;
determine, based on checking the URSP rules received from the V-PCF prior to URSP rules received from a Home Public Land Mobile Network, HPLMN, whether a Single Network Slice Selection Assistance Information, S-NSSAI, is contained within a list of allowed S-NSSAIs; and
responsive to determining that the S-NSSAI is contained within the list of allowed S-NSSAIs, determine that a Route Selection Descriptor, RSD, component of the URSP rules is valid.

Embodiment 15: The UE of embodiment 14, wherein the UE is further adapted to perform the method of embodiment 11.

Embodiment 16: A cellular communications system comprising a network node implementing a Home Policy Control Function, H-PCF, of a Home Public Land Mobile Network, HPLMN, a network node implementing a Visiting Policy Control Function, V-PCF, of a Visiting Public Land Mobile Network, VPLMN, and a User Equipment, UE, wherein:
the network node implementing the H-PCF of the HPLMN is adapted to:
   responsive to the UE registering in the VPLMN and a UE Policy Association being established between the H-PCF and the V-PCF of the VPLMN, provide HPLMN UE policy subscription data for a registered Subscription Permanent Identifier, SUPI, to the V-PCF, the HPLMN UE policy subscription data comprising an indication of whether Local Breakout, LBO, roaming by the UE is allowed for a specified combination of Data Network Name, DNN, and Single Network Slice Selection Assistance Information, S-NSSAI;
the network node implementing the V-PCF of the VPLMN is adapted to:
   responsive to the UE registering in the VPLMN and the UE Policy Association being established between the H-PCF of the HPLMN and the V-PCF of the VPLMN, receive the HPLMN UE policy subscription data for the SUPI from the H-PCF;
   generate URSP rules for the UE in the VPLMN;
   determine, based on the HPLMN UE policy subscription data, whether Local Breakout, LBO, roaming is allowed for a specified DNN or a specified combination of DNN and S-NSSAI in one or more Route Selection Descriptor, RSD, components in the URSP rules; and
   responsive to determining that LBO roaming is allowed, transmit the URSP rules to the UE; and
the UE is adapted to:
   receive, from the V-PCF of the VPLMN, the URSP rules;
   determine, based on checking the URSP rules received from the V-PCF prior to URSP rules received from the HPLMN, whether a S-NSSAI is contained within a list of allowed S-NSSAIs; and
   responsive to determining that the S-NSSAI is contained within the list of allowed S-NSSAIs, determine that an RSD component of the URSP rules is valid.

Those skilled in the art will recognize improvements and modifications to the embodiments of the present disclosure. All such improvements and modifications are considered within the scope of the concepts disclosed herein.

1. A method performed by a Home Policy Control Function, H-PCF, of a Home Public Land Mobile Network, HPLMN, of a cellular communications system for providing User Equipment, UE, Routing and Selection Policy, URSP, rule provisioning in roaming, the method comprising providing HPLMN UE policy subscription data for a Subscription Permanent Identifier, SUPI, to a Visiting Policy Control Function, V-PCF, of a Visiting Public Land Mobile Network, VPLMN, the HPLMN UE policy subscription data comprising an indication of whether Local Breakout, LBO, roaming by a UE is allowed for one or more specified combinations of Data Network Name, DNN, and Single Network Slice Selection Assistance Information, S-NSSAI.

2. The method of claim 1, wherein providing the HPLMN UE policy subscription data for the SUPI to the V-PCF is responsive to the UE registering in the VPLMN and a UE Policy Association being established between the H-PCF and the V-PCF.

3. The method of claim 1, wherein providing the HPLMN UE policy subscription data for the SUPI to the V-PCF is responsive to an update of a UE Policy Association providing a new Public Land Mobile Network Identifier, PLMN-ID.

4. A network node implementing a Home Policy Control Function, H-PCF, of a Home Public Land Mobile Network, HPLMN, of a cellular communications system for providing User Equipment, UE, Routing and Selection Policy, URSP, rule provisioning in roaming, the network node comprising:
one or more transmitters;
one or more receivers; and
processing circuitry associated with the one or more transmitters and the one or more receivers, the processing circuitry configured to cause the network node to provide HPLMN UE policy subscription data for a Subscription Permanent Identifier, SUPI, to a Visiting Policy Control Function, V-PCF, the HPLMN UE policy subscription data comprising an indication of whether Local Breakout, LBO, roaming by a UE is allowed for one or more specified combinations of Data Network Name, DNN, and Single Network Slice Selection Assistance Information, S-NSSAI.

5-7. (canceled)

8. A method performed by a Visiting Policy Control Function, V-PCF, of a Visiting Public Land Mobile Network, VPLMN, of a cellular communications system for providing User Equipment, UE, Routing and Selection Policy, URSP, rule provisioning in roaming, the method comprising:
responsive to a UE registering in the VPLMN and a UE Policy Association being established between a Home Policy Control Function, H-PCF, of a Home Public Land Mobile Network, HPLMN, and the V-PCF of the VPLMN, receiving HPLMN UE policy subscription data for a Subscription Permanent Identifier, SUPI, from the H-PCF;
generating URSP rules for the UE in the VPLMN;
determining, based on the HPLMN UE policy subscription data, whether Local Breakout, LBO, roaming is allowed for one or more specified combinations of Data Network Name, DNN, and Single Network Slice Selection Assistance Information, S-NSSAI, in one or more Route Selection Descriptor, RSD, components in the URSP rules; and
responsive to determining that LBO roaming is allowed, transmitting the URSP rules to the UE.

9. The method of claim 8, wherein generating the URSP rules for the UE in the VPLMN comprises providing a list of Policy Section Identifiers, PSIs, including an identifier of the VPLMN.

10. A network node implementing a Visiting Policy Control Function, V-PCF, of a Visiting Public Land Mobile Network, VPLMN, of a cellular communications system for providing User Equipment, UE, Routing and Selection Policy, URSP, rule provisioning in roaming, the network node comprising:
one or more transmitters;
one or more receivers; and
processing circuitry associated with the one or more transmitters and the one or more receivers, the processing circuitry configured to cause the network node to:
responsive to a UE registering in the VPLMN and a UE Policy Association being established between a Home Policy Control Function, H-PCF, of a Home Public Land Mobile Network, HPLMN, and the V-PCF of the VPLMN, receive HPLMN UE policy subscription data for a Subscription Permanent Identifier, SUPI, from the H-PCF;
generate URSP rules for the UE in the VPLMN;
determine, based on the HPLMN UE policy subscription data, whether Local Breakout, LBO, roaming is allowed for one or more specified combinations of Data Network Name, DNN, and Single Network Slice Selection Assistance Information, S-NSSAI, in one or more Route Selection Descriptor, RSD, components in the URSP rules; and
responsive to determining that LBO roaming is allowed, transmit the URSP rules to the UE.

11-13. (canceled)

14. A method performed by a User Equipment, UE, of a cellular communications system for providing UE Routing and Selection Policy, URSP, rule provisioning in roaming, the method comprising:
determining, based on checking Visiting Public Land Mobile Network, VPLMN, generated URSP rules prior to URSP rules received from a Home Public Land Mobile Network, HPLMN, whether a Single Network Slice Selection Assistance Information, S-NSSAI, is contained within a list of allowed S-NSSAIs; and
responsive at least to determining that the S-NSSAI is contained within the list of allowed S-NSSAIs, determining that a Route Selection Descriptor, RSD, component of the VPLMN-generated URSP rules is valid.

15. The method of claim 14, further comprising receiving, from a Visiting Policy Control Function, V-PCF, of a VPLMN, the VPLMN-generated URSP rules.

16. The method of claim 14, further comprising registering, by the UE, in the VPLMN;
wherein the UE was previously provisioned with the VPLMN-generated URSP rules by a Visiting Policy Control Function, V-PCF, of a VPLMN and the URSP rules received from the HPLMN.

17. The method of claim 14, wherein the UE was previously provisioned with one of the VPLMN-generated URSP rules by a Visiting Policy Control Function, V-PCF, of a VPLMN and the URSP rules received from the HPLMN.

18. The method of claim 14, further comprising identifying the VPLMN-generated URSP rules by verifying that a Public Land Mobile Network Identifier, PLMN-ID, in a list of Policy Section Identifiers, PSIs, includes an identifier of the VPLMN.

19. A User Equipment, UE, comprising:
one or more transmitters;
one or more receivers; and
processing circuitry associated with the one or more transmitters and the one or more receivers, the processing circuitry configured to cause the UE to:
determine, based on checking Visiting Public Land Mobile Network, VPLMN, generated UE Routing and Selection Policy, URSP, rules prior to URSP rules received from a Home Public Land Mobile Network, HPLMN, whether a Single Network Slice Selection Assistance Information, S-NSSAI, is contained within a list of allowed S-NSSAIs; and
responsive at least to determining that the S-NSSAI is contained within the list of allowed S-NSSAIs, determine that a Route Selection Descriptor, RSD, component of the VPLMN-generated URSP rules is valid.

20-23. (canceled)
